(19) United States
(12) Patent Application Publication
(10) Pub. No.: US 2008/0308362 A1
(43) Pub. Date: Dec. 18, 2008

(54) CABLE MANAGEMENT ASSEMBLY AND METHOD FOR CONSTRUCTION ELEVATOR SYSTEMS

(76) Inventor: Stefan Ernest Tucker, Valparaiso, IN (US)

Correspondence Address: HARTMAN & HARTMAN, P.C., 552 EAST 700 NORTH, VALPARAISO, IN, 46383, US

(21) Appl. No.: 12/133,848

(22) Filed: Jun. 5, 2008

Related U.S. Application Data
(60) Provisional application No. 60/941,979, filed on Jun. 5, 2007.

(51) Int. Cl. B66B 7/06

(52) U.S. Cl. 187/414

(57) ABSTRACT

A cable management assembly (40) and method by which cables used to hoist and secure a temporary elevator car (18) are prevented from becoming tangled as the elevator car (18) is raised and lowered within an elevator hatchway (10) during construction of a multistory building (12). The assembly (40) is adapted for installation below the car (18) within the hatchway (10), and includes a first member (42) having second and third members (44) connected at opposite longitudinal ends thereof. A mechanism (54,56A,56B) associated with the second and third members (44) movably engages vertical elevator guide rails (22) within the hatchway (10) to enable the assembly (40) to vertically traverse the hatchway (10). Another mechanism (58,60,62) movably and reversibly routs a hoist cable (24) to and from the assembly (40).

### CROSS REFERENCE TO RELATED APPLICATIONS

This application claims the benefit of U.S. Provisional Application No. 60/941,979, filed Jun. 5, 2007, the contents of which are incorporated herein by reference.

### BACKGROUND OF THE INVENTION

The present invention generally relates to construction methods, equipment, and systems used during the construction of a building. More particularly, this invention relates to a cable management assembly and method by which cables used to hoist and secure a temporary elevator car are prevented from becoming entangled as the elevator car is raised and lowered within an elevator hatchway during construction of a multistory building.

During the installation of components of an elevator system in a building under construction, a temporary elevator car is often installed to deliver the elevator components and support the elevator constructors within the hatchway (hoistway). One such approach is represented in FIG. 1, which schematically represents a hatchway 10 within a multistory building 12 under construction. A jump deck 14 is placed over the elevator hatchway 10 at an upper floor 16 of the building 12, and a temporary elevator car 18 (or “car sling”) is suspended with a hoist cable 24 beneath the jump deck 14. The elevator car 18 is depicted in FIG. 1 as comprising a working deck 19A on which the elevator constructors stand during installation of the elevator components, and a secondary deck 19B on which supplies can be stored. The secondary deck 19B is attached to the working deck 19A with stiles 23. The working deck 19A may be supported by the crosshead (not shown) of the permanent elevator car that will later be installed in the hatchway 10, and the secondary deck 19B is shown supported by a safety plank 21 on which the permanent elevator car will be supported. Safeties (not shown) on the safety plank 21 are operated by a safety cable 34 routed from a governor 35 on the jump deck 14 to the safety plank 21 through a governor tension sheave 38 mounted by a bracket 36 within the pit 32 at the bottom of the hatchway 10. The car 18 travels up and down within the hatchway 10 on a temporary hoist cable 24 (typically a wire rope) by means of a hoist motor 20 on the working deck 19A, and is equipped with shoes (not shown) or similar components that engage the installed guide rails 22. The hoist cable 24 is attached to the deck 19A, passes over a sheave 28 suspended beneath the jump deck 14 to a hoist motor 20 on the working deck 19A, and then passes down through the hatchway 10 and through or around the car 18, from which the loose or “dead” end 30 of the hoist cable 24 hangs freely downward toward the pit 32. As the car 18 travels upward through the hatchway 10 under the action of the hoist motor 20, the loose end 30 of the hoist cable 24 runs downward toward and eventually into the pit 32. When installation of the elevator system components has been completed up to the jump deck 14, the jump deck 14 is raised (jumped) to a higher floor (not shown) of the building 12. Because the car 18 is raised along with the jump deck 14, the car 18 must be lowered from the deck 14 with the hoist cable 24 to resume installation of elevator components at the prior location of the deck 14 in the hatchway 10.

There are various problems and hazards associated with the building and use of temporary elevator cars of the type represented in FIG. 1. One problem is that, as the elevator system is installed and the temporary car 18 is raised to higher levels, the loose end 30 of the hoist cable 24 can be difficult to control. When the loose end 30 of the cable 24 feeds into the pit 32 as the elevator car 18 runs up through the hatchway 10, the loose end 30 of the cable 24 can become tangled with equipment in the pit 32 and suspended in the hatchway 10, such as a temporary power supply cable 26 that supplies power to the car 18 during construction. When this happens, the elevator constructors must stop work and free the tangled cable 24. This task is not only a nuisance that delays the construction process, but can also be hazardous for the constructors.

Another issue is that, when the jump deck 14 is raised within the hatchway 10, the bracket 36 of the safety cable 34 must be physically detached from a rail 22 within the pit 32 by a constructor, the cable 34, bracket 36, and tension sheave 38 must be raised up through the hatchway 10, and then the bracket 38 reattached to the guide rail 22 at a higher level within the hatchway 10. This operation is hazardous, in that it entails raising a significant amount of weight due to the weight of the cable 34, bracket 36, and sheave 38. In addition, this operation is typically performed by a constructor who must typically stand on a beam (not shown) spanning the hatchway 10.

In view of the above, it would be desirable if an improved method were available for by which the temporary cables used during construction of an elevator system could be handled and managed to avoid the above-noted issues.

### BRIEF SUMMARY OF THE INVENTION

The present invention provides a cable management assembly and method by which cables used to hoist and secure a temporary elevator car are prevented from becoming tangled as the elevator car is raised and lowered within an elevator hatchway during construction of a multistory building.

According to a first aspect of the invention, the cable management assembly is adapted for installation below an elevator car within an elevator hatchway of a building. The cable management assembly includes first, second, and third members. The first member has a longitudinal extent and oppositely-disposed longitudinal ends, and the second and third members are connected to the first member at the longitudinal ends thereof. At least one of the second and third members is longitudinally extendable relative to the first member for adjusting a length of the cable management assembly defined by the first, second, and third members. The first, second, and third members define an upper side of the cable management assembly adapted to face upward when the cable management assembly is installed in the hatchway. The cable management assembly further includes a mechanism associated with each of the second and third members for movably engaging vertical elevator guide rails within the hatchway so as to enable the cable management assembly to vertically traverse the hatchway. The cable management assembly also includes a mechanism for movably and reversibly routing a hoist cable toward the upper side of the cable management assembly, along a portion of the cable management assembly, and away from the upper side of the cable management assembly.

According to a second aspect of the invention, a method is provided for raising and lowering the elevator car within the hatchway with a cable management assembly, preferably in accordance with claim 1. The cable management assembly is preferably installed below the elevator car within the hatchway. The movable engaging mechanism movably engages the guide rails within the hatchway to enable the cable management assembly to vertically traverse the hatchway, and the hoist cable is routed through the routing means so as to have first and second portions engaging the routing means at two longitudinally spaced locations of the cable management assembly. Also in the preferred embodiment, the elevator car is suspended by the hoist cable from a fixed platform, the first portion of the hoist cable is coupled to a hoist on the elevator car, the second portion of the hoist cable is coupled to the car through a spool, and the elevator car and cable management assembly can both be raised by hoisting the hoist cable with the hoist.

Significant advantages of this invention include the elimination of a loose end of the hoist cable hanging into the pit of the elevator hatchway by routing the hoist cable through the cable management assembly in a manner that allows an elevator constructor to freely raise and lower the car and hoist cable in a safe manner. The cable management assembly can also be adapted to mount a tension sheave for a safety cable associated with the elevator car, so that the safety cable can also be raised and lowered with the car in a safe manner.

Other objects and advantages of this invention will be better appreciated from the following detailed description.

### BRIEF DESCRIPTION OF THE DRAWINGS

FIG. 1 represents a hatchway within a building under construction, in which equipment is present for installing components of an elevator system within the hatchway in accordance with the prior art.

FIG. 2 represents a view of a hatchway similar to FIG. 1, but further utilizing a cable management assembly in accordance with a preferred embodiment of the invention.

FIGS. 3 and 4 are side and top views, respectively, of the cable management assembly of FIG. 2.

### DETAILED DESCRIPTION OF THE INVENTION

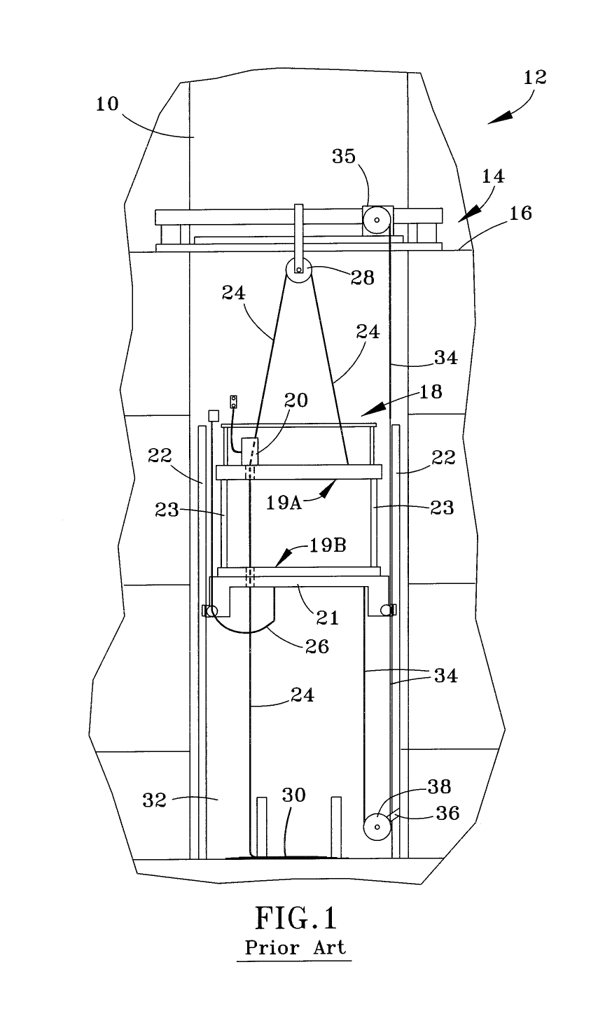

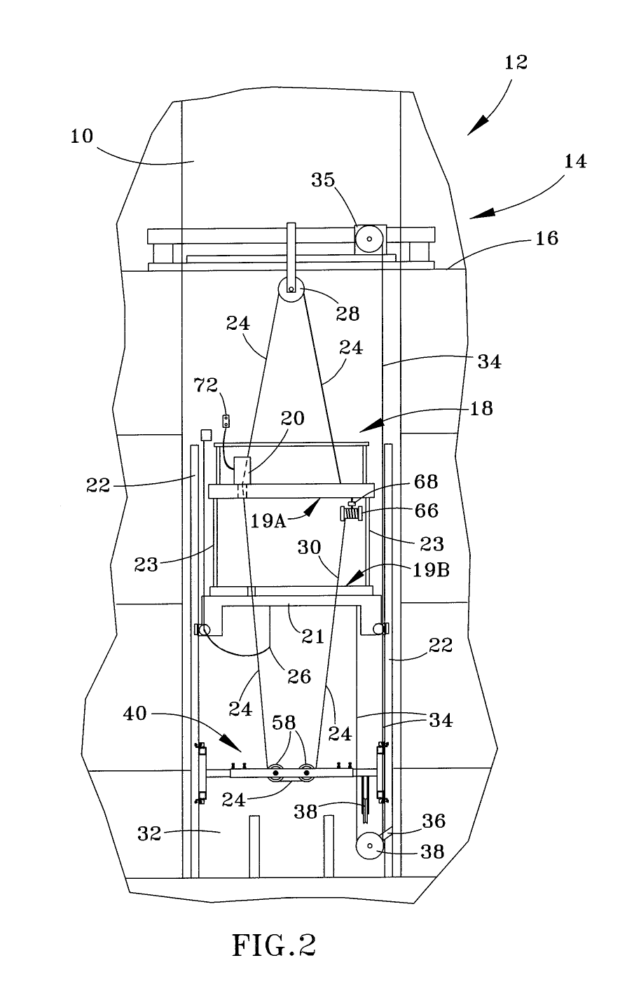

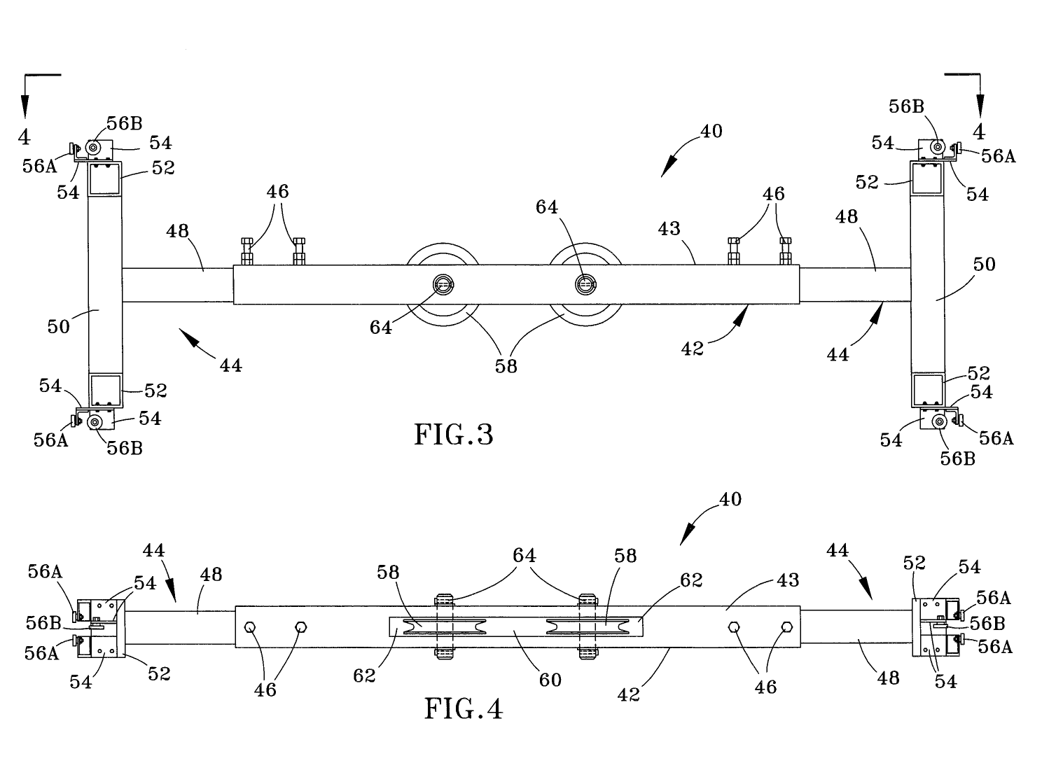

FIGS. 3 and 4 represent a cable management assembly 40 according to a preferred embodiment of the invention, and FIG. 2 depicts the cable management assembly 40 installed for use in a hatchway 10 of a multistory building 12. The invention finds particular use in buildings under construction, similar to the scenario described for FIG. 1. As such, FIG. 2 uses consistent reference numbers to identify the same or functionally similar structures to those identified in FIG. 1. It should be further noted that the drawings are drawn for purposes of clarity when viewed in combination with the following description, and therefore are not to scale.

The assembly 40 preferably comprises three basic components: a middle section 42 and two end sections 44 at longitudinally-opposed ends of the middle section 42. Structural steel grades, for example, carbon steels such as ASTM A36 and ASTM A500, are suitable materials for the structural components of the assembly 40, though the use of other materials is foreseeable. The middle and end sections 42 and 44 are shown as having square tubular cross-sections, though it is foreseeable that various structural elements with different cross-sections could be used to construct the assembly 40. Each end section 44 is generally T-shaped, with a leg section 48 and an arm section 50 that may be constructed by welding two tubes as evident from FIGS. 3 and 4. The leg section 48 of each end section 44 is sized to telescope with one of the opposite ends of the middle section 42 and be secured therewith using bolts 46 or another suitable fastener. As represented in FIGS. 3 and 4, the leg sections 48 have smaller cross-sections than the middle section 42 to provide the desired telescoping arrangement, though it is foreseeable that the middle section 42 could telescope into the end sections 44. In the embodiment shown, suitable cross-sectional dimensions for the middle section 42 and end members 44 are about 4.0 inches (about 10 cm) and about 3.5 inches (about 9 cm), respectively, though these dimensions can vary. The end sections 44 are adapted to be extendable relative to the middle section 42 to enable the length of the cable management assembly 40 to be expanded to fit essentially any elevator rail dimension, for example, up to about eight feet (about 2.5 meters) or so, with lesser and greater expanses also being foreseeable.

A guide tube 52 is welded or otherwise attached to the outer extremity of each arm section 50, and a guide plate 54 is bolted or otherwise attached to each guide tube 52. Each guide plate 54 is shown as carrying cam followers 56A and 56B for rotational engagement with one of the guide rails 22 within the hatchway 10 as represented in FIG. 2. Two followers 56A are oriented for engaging opposite surfaces of a rail 22, while a third follower 56B is oriented to engage the surface of the rail 22 facing into the hatchway 10. Suitable diameters for the followers 56A and 56B are about 1.125 and 1.5 inches (about 2.9 and 3.8 cm), respectively, with smaller and larger diameters being foreseeable. Each set of followers 56A and 56B at one end of an arm section 50 is spaced apart from the followers 56A and 56B at the opposite end of the same arm section 50 for stability and to ensure that the assembly 40 is capable of vertically traversing the hatchway 10, preferably while oriented substantially horizontal as represented in FIG. 2. For this purpose, the sets of followers 56A and 56B may be spaced about two feet (about 0.6 meter) apart on each arm section 50, though lesser and greater separations are foreseeable.

The cable management assembly 40 is configured to enable the hoist cable 24 to be routed through the assembly 40 via entry and exit points located at longitudinally spaced locations at an upper side 43 of the assembly 40. The embodiment shown in FIGS. 2, 3 and 4 is configured to achieve this capability with at least two rollers 58 disposed in a slot 60 defined in the upper side 43 of the middle section 42. The slot 60 preferably extends entirely through the middle section 42 to the opposite lower side of the section 42, as evident from FIGS. 3 and 4. The rollers 58 are rotatably mounted on pins 64 within the slot 60 so that their axes of rotation (as defined by the pins 64) are transverse to the longitudinal length of the middle section 42 and, when the assembly 40 is installed as shown in FIG. 2 with the side 43 facing upward toward the car 18, horizontal with respect to the vertical guide rails 22. The rollers 58 are spaced within the slot 60 to define two oppositely-disposed openings 62 through which the hoist cable 24 of the temporary elevator car 18 can freely pass to the lower side of the assembly 40, as represented in FIG. 2. A suitable diameter for the rollers 58 is about eight inches (about 20 cm), though the use of larger and smaller rollers 58 is foreseeable. Based on the use of eight-inch diameter rollers 58, a suitable center-to-center spacing between the rollers 58 is about fifteen inches (about 40 cm). In practice, MSD nylon has been found to be a suitable material for the rollers 58, though the use of other materials is foreseeable. While both rollers 58 are shown as being mounted within the same slot 60, it is foreseeable that the rollers 58 could be mounted within separate slots in the middle section 42.

The cable management assembly 40 is shown in FIG. 2 as being mounted between the elevator guide rails 22 within the pit 32, though it will be apparent that the assembly 40 can and will be positioned at other locations within the hatchway 10, depending on the stage of building construction. With the middle section 42 approximately centered between the elevator guide rails 22, the two end sections 44 are slid out to engage the follows 56A and 56B with their respective rails 22. The two end sections 44 are then locked in place with the bolts 46. The temporary hoist cable 24, already fed over the sheave 28 and through the hoist motor 20 on the deck 19A (consistent with FIG. 1), is then fed down past or through the car 18 and to the cable management assembly 40 in the pit 32. The loose end 30 of the cable 24 is then passed down through one of the openings 62 of the assembly 40, around both rollers 58, up through the other opening 62, and then up through the hatchway 10 to the deck 19A. The loose end 30 of the hoist cable 24 is wrapped on a spool 66 mounted with a swivel 68 beneath the deck 19A. The swivel 68 enables the spool 66 to freely rotate, reducing the likely hood that the cable 24 will not properly spool onto the spool 66. The routing of the cable 24 through the rollers 58 of the cable management assembly 40 provides a two-to-one set up, similar to the two-to-one set up between the hoist motor 20 and working deck 19A through the sheave 28 on the jump deck 14.

FIG. 2 further shows two options for supporting the safety cable 34. In the first option, the safety cable 34 is routed through the pit 32 and tensioned with the governor tension sheave 38, similar to that of FIG. 1. The second option is to attach the tension sheave 38 to the cable management assembly 40, as shown in FIG. 2 minus the safety cable 34.

With the arrangement described above, if the hoist motor 20 is operated to cause the elevator car 18 to travel upward within the hatchway 10, the temporary hoist cable 24 travels downward through the hatchway 10 to the assembly 40, around its two rollers 58, and then upward to the spool 66 beneath the working deck 19A. If the elevator car 18 travels downward, the hoist cable 24 travels around the two rollers 58 and up through the motor 20 on the working deck 19A. The hoist cable 24 is essentially a continuous loop starting at the working deck 19A, through the sheave 28 beneath the jump deck 14, through the hoist motor 20 on the working deck 19A, through the car 18 to the cable management assembly 40, and then back up to the spool 66 beneath the working deck 19A. Beneath the car 18, the cable management assembly 40 is secured between the guide rails 22 and suspended by the hoist cable 24, such that the cable 24 does not lie in the floor of the pit 32 and the assembly 40 tensions the cable 24.

When installation of the guide rails 22 and other elevator system components has been completed up to the jump deck 14, the jump deck 14 is raised (jumped) to a higher floor (not shown) of the building 12. Because the car 18 would be raised along with the deck 14 during the jumping operation, prior to the jump the safeties on the elevator car 18 are set and the motor 20 is operated to run a sufficient length of the hoist cable 24 upward and out onto the floor of the deck 19A to enable the jump deck 14 to be raised the desired number of floors above the car 18. Prior to this operation, a large amount of the temporary hoist cable 24 was under the car 18 and routed through the assembly 40. As the hoist cable 24 is run out onto the floor of the deck 19A with the motor 20, the assembly 40 is raised up out of the pit 32 and through the hatchway 10 until stopped at some distance beneath the car 12. Concurrently, the governor tension sheave 38 (if mounted to the assembly 40) is raised with the assembly 40.

Once the jump deck 14 has been jumped and before the elevator car 18 is taken off the safeties and again suspended beneath the jump deck 14, the cable management assembly 40 is lowered by feeding the remaining length of cable 24 on the working deck 19A back down through the motor 20. If attached to the assembly 40, the governor tension sheave 38 is also lowered to put tension on the safety cable 34. As such, the hoist and safety cables 24 and 34 are both managed in a safe and secure manner, without placing constructors in hazardous situations over the hatchway 10 or in the pit 32. Furthermore, the motor 20 can be operated by an elevator constructor standing on the elevator car 18 using a push-button control 72 that allows both cables 24 and 34 to run simultaneously, with the result that the constructors are also able to avoid other common injuries associated with the construction of elevators, such as falling, back injuries, and strains or muscle pulls due to the lifting and carrying of heavy weights.

While the invention has been described in terms of a preferred embodiment, it is apparent that other forms could be adopted by one skilled in the art. For example, the physical configurations of the cable management assembly 40, the hatchway 10, and other aspects of the building construction could differ from those shown, and materials and processes other than those noted could be used. Therefore, the scope of the invention is to be limited only by the following claims.

1. A cable management assembly (40) adapted for installation below an elevator car (18) within an elevator hatchway (10) of a building (12), the cable management assembly (40) comprising:
a first member (42) having a longitudinal extent and oppositely-disposed longitudinal ends;
second and third members (44) connected to the first member (42) at the longitudinal ends thereof, at least one of the second and third members (44) being longitudinally extendable relative to the first member (42) for adjusting a length of the cable management assembly (40) defined by the first, second, and third members (42,44);
means (54,56A,56B) associated with each of the second and third members (44) for movably engaging vertical elevator guide rails (22) within the hatchway (10) so as to enable the cable management assembly (40) to vertically traverse the hatchway (10); and
means (58,60,62) for movably and reversibly routing a hoist cable (24) to and from the cable management assembly (40).

2. The cable management assembly (40) according to claim 1, wherein the movable engaging means (54,56A,56B) is configured to orient the longitudinal extent of the first member (42) to be substantially perpendicular to the vertical guide rails (22).

3. The cable management assembly (40) according to claim 1, wherein the movable engaging means (54,56A,56B) comprises followers (56A,56B) for engaging three different surfaces of each of the vertical guide rails (22).

4. The cable management assembly (40) according to claim 3, wherein at least some of the followers (56A,56B) are rotatable.

5. The cable management assembly (40) according to claim 1, wherein the second and third members (44) are telescopingly coupled to the first member (42).

6. The cable management assembly (40) according to claim 1, wherein each of the second and third members (44) is T-shaped and comprises a leg section (48) and an arm section (50) transverse to the leg section (48), and the movable engaging means (54,56A,56B) comprises followers (56A,56B) spaced apart on the arm section (50).

7. The cable management assembly (40) according to claim 1, wherein the routing means (58,60,62) routs the hoist cable (24) longitudinally along the cable management assembly (40).

8. The cable management assembly (40) according to claim 1, wherein the routing means (58,60,62) comprises at least two rollers (58) spaced longitudinally apart on the first member (42).

9. The cable management assembly (40) according to claim 8, wherein the at least two rollers (58) are disposed within at least one slot (60) within the first member (42).

10. The cable management assembly (40) according to claim 8, wherein each of the at least two rollers (58) has an axis of rotation (64) transverse to the longitudinal extent of the first member (42).

11. The cable management assembly (40) according to claim 10, wherein the movable engaging means (54,56A,56B) is configured to orient the longitudinal extent of the first member (42) to be substantially horizontal and orient the axis of rotation (64) of each of the at least two rollers (58) to be substantially horizontal.

12. The cable management assembly (40) according to claim 1, further comprising a governor tension sheave (38) attached to the cable management assembly (40) for routing and tensioning a cable (34).

13. The cable management assembly (40) according to claim 1, wherein the cable management assembly (40) is installed below the elevator car (18) within the hatchway (10), the movable engaging means (54,56A,56B) is movably engaged with the guide rails (22) within the hatchway (10) to enable the cable management assembly (40) to vertically traverse the hatchway (10), and the hoist cable (24) is routed through the routing means (58,60,62) so as to have first and second portions engaging the routing means (58,60,62) at two spaced locations of the cable management assembly (40).

14. The cable management assembly (40) according to claim 13, wherein the elevator car (18) is suspended by the hoist cable (24) from a fixed platform (14), the first portion of the hoist cable (24) is coupled to a hoist (20) on the elevator car (18), the second portion of the hoist cable (24) is coupled to the elevator car (18) through a spool (66), and the elevator car (18) and the cable management assembly (40) can both be raised by hoisting the hoist cable (24) with the hoist (20).

15. A method comprising raising and lowering the elevator car (18) within the hatchway (10) with the hoist cable (24), the cable management assembly (40) of claim 1 being suspended beneath the elevator car (18) with the hoist cable (24).

16. The method according to claim 15, wherein the hoist cable (24) is routed through the routing means (58,60,62) so as to have first and second portions engaging the routing means (58,60,62) at two spaced locations of the cable management assembly (40).

17. The method according to claim 15, further comprising attaching a governor tension sheave (38) to the cable management assembly (40) and routing and tensioning a cable (34) therewith.

18. The method according to claim 15, wherein the cable management assembly (40) is installed below the elevator car (18) within the hatchway (10), the movable engaging means (54,56A,56B) is movably engaged with the guide rails (22) within the hatchway (10) to enable the cable management assembly (40) to vertically traverse the hatchway (10), and the hoist cable (24) is routed through the routing means (58,60,62).

19. The method according to claim 18, wherein the elevator car (18) is suspended by the hoist cable (24) from a fixed platform (14), the first portion of the hoist cable (24) is coupled to a hoist (20) on the elevator car (18), the second portion of the hoist cable (24) is coupled to the elevator car (18), and the elevator car (18) is raised by drawing the hoist cable (24) downward through the hoist (20).

20. The method according to claim 19, further comprising raising and lowering the cable management assembly (40) by causing the hoist cable (24) to travel upward and downward, respectively, through the hoist (20).
